(19) United States
(12) Patent Application Publication
(10) Pub. No.: US 2007/0020421 A1
(43) Pub. Date: Jan. 25, 2007

(54) Cylindrical part

(75) Inventor: Kazuya Hirose, Hatogaya-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Imaging Corp., Tokyo (JP)

(21) Appl. No.: 11/477,283

(22) Filed: Jun. 29, 2006

(30) Foreign Application Priority Data
Jul. 8, 2005 (JP) 2005-200578

(51) Int. Cl. B32B 1/08; B32B 23/02

(52) U.S. Cl. 428/36.9; 428/192

(57) ABSTRACT

A cylindrical member, which is a cylindrical part molded by injection molding, has a cylindrical shape having a substantially uniform thickness in a circumferential direction and whose both end-face edge portions are opened, in which a band-state groove portion for forming a thin portion along the outer circumference of a cylindrical center portion forming a cylindrical portion and a thick edge portion along the outer circumference of the both end-face edge portions are provided. Since the band-state groove portion and the thick edge portion are provided, the temperature of the cylindrical member does not become relatively high at the center portion, while the temperature of the end-face portions does not become relatively low at molding, and molding contraction rates are made uniform in general and the cylindrical member with good form accuracy can be obtained.

This application claims benefit of Japanese Application No. 2005-200578 filed in Japan on Jul. 8, 2005, the contents of which are incorporated by this reference.

### BACKGROUND OF THE INVENTION

1. Field of the Invention

The present invention relates to a cylindrical part obtained by injection molding.

2. Description of the Related Art

When a cylindrical resin part is produced by injection molding in the conventional molding technique, there is a tendency that a diameter close to the center is contracted and reduced. The reason why the center portion becomes small will be described using FIGS. 23, 24.

FIG. 23 shows temperature distributions of a die 101 and a cylindrical part 103 in isotherm display when resin filling is completed in conventional molding of the resin cylindrical part. Arrow directions in the diagram represent directions in which a temperature on the isotherm is lowered.

When a molten resin material is filled in a cavity in the die 101, heat of the resin is moved to the die, which raises the temperature of the die 101. At that time, since there are few spots for the heat to escape in the vicinity of the center on an inner circumferential surface of the cylindrical part 103, the resin temperature is higher around inside a center portion 103a of the cylindrical part 103 and the die temperature is also particularly high. On the contrary, the die temperature close to the outer circumference of the cylindrical part 103 is relatively low. Also, since both ends 103b of the cylindrical part 103 are in contact on three faces of the die, the heat of the resin is likely to move to the die, which lowers the resin temperature around here.

With regard to the resin, when the molten resin is cooled and solidified, if the resin temperature in the filled state is high, its contraction rate is raised (in other words, a dimensional change of a product after molding is large), while if the resin temperature is low, the contraction rate is lowered (in other words, the dimensional change of the product after molding is small).

In the state where the resin cylindrical part 103 shown in FIG. 23 is removed from the die, since the temperature around the center portion 103a of the cylindrical part 103 whose resin temperature was high in the filled state is high, the contraction amount is large, which reduces the diameter, while the contraction amount close to the ends 103b of the cylindrical part is small and the diameter is relatively larger than that of the center portion 103a. FIG. 24 is a sectional view showing a contraction state in the radial direction of the conventional resin cylindrical part 103 after molding in an exaggerated manner. Specifically, when the outer diameter is 30 mm, the length is 30 mm, and the thickness is 1.6 mm, the resin cylindrical part 103 is in the hourglass shape with a dimensional difference (deformation amount) δ0 of approximately 0.03 mm on a radius between the center portion and the end.

When a part as the cylindrical part 103 molded by the above-mentioned conventional molding technique in which the diameter around the center is small and the diameter close to the end is relatively largely deformed is used for a part of a precision instrument such as a cam frame, for example, which is a part of lens barrels for a camera, the following state would be caused.

FIGS. 25, 26 are examples in which the cylindrical part deformed as above is applied as the prior art in a lens barrel for a camera and they are sectional views showing fitting states between a cam frame 104 and a zoom frame 105 driven for advance/retreat. FIG. 25 shows a state where a cam follower 106 of the zoom frame is fitted in a cam groove at the center of the cam frame 104, and FIG. 26 shows a state where the cam follower 106 is fitted in the cam groove at the end of the cam frame 104.

In the above lens barrel for a camera, a cam groove 104c with a trapezoidal section is integrally formed on the inner circumference of the cam frame 104. On the inner circumference of the cam frame 104, the zoom frame 105 is fitted capable of advance/retreat. On the outer circumference of the zoom frame 105, the cam follower 106 slidably fitted in the cam groove 104c is fixed. When the zoom frame 105 is relatively rotated, the zoom frame 105 is relatively moved forward/backward in a direction of an optical axis O with respect to the cam frame 104.

In the fitted state in FIG. 25, a gap between the inner circumference of the cam frame 104 and the outer circumference of the zoom frame 105 and a fitting gap between the cam groove 104c of the center portion 103a and the cam follower 106 are extremely small, respectively, and relative positions of the cam frame 104 and the zoom frame 105 are held with high accuracy.

When the zoom frame 105 is rotated from this state, the cam follower 106 is slid along the cam groove 104c while being rotated and the zoom frame 105 is fed out to a position shown in FIG. 26. However, in the state in FIG. 26, since the zoom frame 105 is fitted at a portion where the diameter close to the end 104b of the cam frame 104 is largely deformed, a gap S1 in the radial direction between the zoom frame 105 and the cam frame 104 is increased, and a fitting gap S2 is also generated between the cam follower 106 and the cam groove 104c at the same time.

### SUMMARY OF THE INVENTION

The present invention is to obtain a cylindrical part with excellent form accuracy with a simple construction in a cylindrical part molded by injection molding.

One cylindrical part of the present invention has, in a cylindrical part molded by injection molding, a cylindrical portion whose end faces are open and a band-state groove portion provided in the circumferential direction at the center of the cylindrical portion.

Another cylindrical part of the present invention has, in a cylindrical part molded by injection molding, a cylindrical portion whose end faces are open and a thick edge portion provided thickly in the circumferential direction at both end-face edge portions of the cylindrical portion.

Still another cylindrical part of the present invention has, in a cylindrical part molded by injection molding, a cylindrical portion having a substantially uniform thickness whose end faces are open and a thick edge portion provided thickly in the circumferential direction at both end-face edge portions of the cylindrical portion.

Still another cylindrical part of the present invention has, in a cylindrical part molded by injection molding, a cylindrical portion whose end faces are open and having a spiral groove on an outer circumferential or an inner circumferential surface and a plurality of recess portions aligned in the circumferential direction at the center of the cylindrical portion and provided with the spiral groove between them.

Still another cylindrical part of the present invention has, in a cylindrical part molded by injection molding, a cylindrical portion whose end faces are open and having an inner circumferential face portion with a female thread formed and a smooth inner circumferential face portion without the female thread, and a band-state groove portion provided on the outer circumference of the cylindrical portion and the outer circumference of the smooth inner circumferential face portion.

Still another cylindrical part of the present invention has, in a cylindrical part molded by injection molding, a cylindrical portion whose end faces are open and having an inner circumferential face portion with a constant outer diameter except in the vicinity of the both end faces and the female thread and a smooth inner circumferential face portion with a constant inner diameter without the female thread, and a thick edge portion provided thickly on the outer circumference in the circumferential direction of the both end-face edge portions.

Still another cylindrical part of the present invention has, in a cylindrical part molded by injection molding, a cylindrical portion whose end faces are open, a male thread portion provided on the outer circumference close to one end of the cylindrical portion and a thick edge portion provided thickly in the circumferential direction of the edge portion of the other end face of the cylindrical portion.

Other characteristics and benefits of the present invention will be made apparent by the following description.

### BRIEF DESCRIPTION OF THE DRAWINGS

FIG. 1 is a side view showing a section of an upper half of a cylindrical member, which is a cylindrical part of a first preferred embodiment of the present invention;

FIG. 2 is a diagram of temperature distributions of a die when filling of a resin is finished and the cylindrical member in isotherm display at molding of the cylindrical member in FIG. 1;

FIG. 3 is a diagram showing relations between thickness of an essential part of the cylindrical member in FIG. 1 and a resin temperature;

FIG. 4 is an enlarged side view of a deformed state of the cylindrical member in FIG. 1 caused by molding showing an upper half section;

FIG. 5 is a side view showing a section of an upper half of a first variation of the cylindrical member of the first preferred embodiment in FIG. 1;

FIG. 6 is a side view showing a section of an upper half of a second variation of the cylindrical member of the first preferred embodiment in FIG. 1;

FIG. 7 is a side view showing a section of an upper half of a third variation of the cylindrical member of the first preferred embodiment in FIG. 1;

FIG. 8 is a side view showing a section of an upper half of a fourth variation of the cylindrical member of the first preferred embodiment in FIG. 1;

FIG. 9 is a side view showing a section of an upper half of a fifth variation of the cylindrical member of the first preferred embodiment in FIG. 1;

FIG. 10 is an enlarged sectional view of an essential part of the cylindrical member in FIG. 9;

FIG. 11 is a side view showing a section of an upper half of a sixth variation of the cylindrical member of the first preferred embodiment in FIG. 1;

FIG. 12 is a view on arrow G in FIG. 11;

FIG. 13 is a side view showing a section of an upper half of a cylindrical member, which is a cylindrical part of a second preferred embodiment of the present invention;

FIG. 14 is an enlarged side view of a deformed state of the cylindrical member in FIG. 13 caused by molding showing an upper half section;

FIG. 15 is a side view showing a section of an upper half of a cylindrical member, which is a cylindrical part of a third preferred embodiment of the present invention;

FIG. 16 is an enlarged side view of a deformed state of the cylindrical member in FIG. 15 caused by molding showing an upper half section;

FIG. 17 is a sectional view of a cylindrical member, which is a cylindrical part of a fourth preferred embodiment of the present invention;

FIG. 18 is an extended view of the cylindrical member in FIG. 17 seen from the inner circumference side;

FIG. 19 is a side view showing a section of an upper half of a first variation of the cylindrical part of the fourth preferred embodiment in FIG. 17;

FIG. 20 is a side view showing a section of an upper half of a second variation of the cylindrical part of the fourth preferred embodiment in FIG. 17;

FIG. 21 is a side view showing a section of an upper half of a cylindrical member, which is a cylindrical part of a fifth preferred embodiment of the present invention;

FIG. 22 is a side view showing a section of an upper half of a variation of the cylindrical member of the fifth preferred embodiment in FIG. 17;

FIG. 23 is a diagram of temperature distributions of a die when filling of a resin is finished and the cylindrical part in isotherm display at molding of the conventional resin cylindrical member;

FIG. 24 is a sectional view showing a contraction state in the radial direction after molding of the conventional resin cylindrical part in FIG. 24 in an exaggerated manner;

FIG. 25 is an example of application of the deformed cylindrical part to a conventional lens barrel for a camera as in FIG. 24 showing a state where a cam frame and a zoom frame are fitted with each other at the central portion; and

FIG. 26 is a sectional view showing a state of fitting at the ends in the cam frame and the zoom frame in FIG. 25.

### DESCRIPTION OF THE PREFERRED EMBODIMENTS

Preferred embodiments of the present invention will be described using the attached drawings.

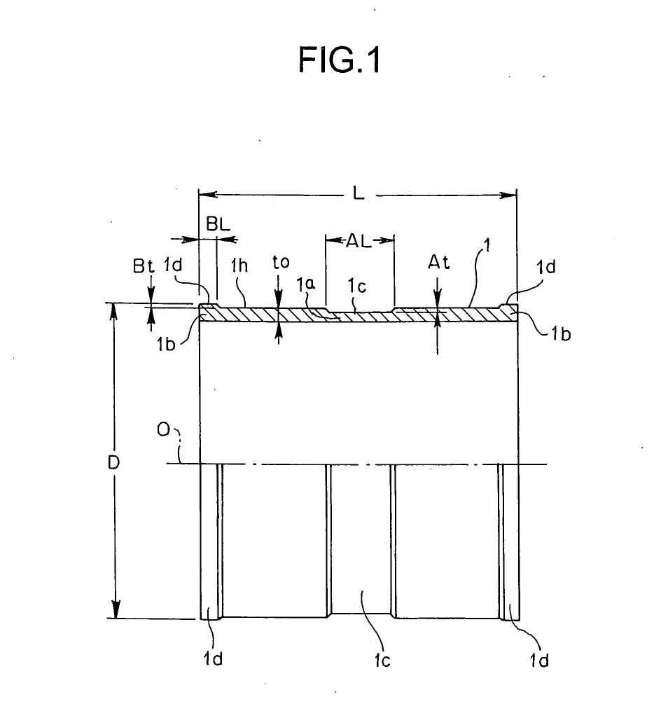

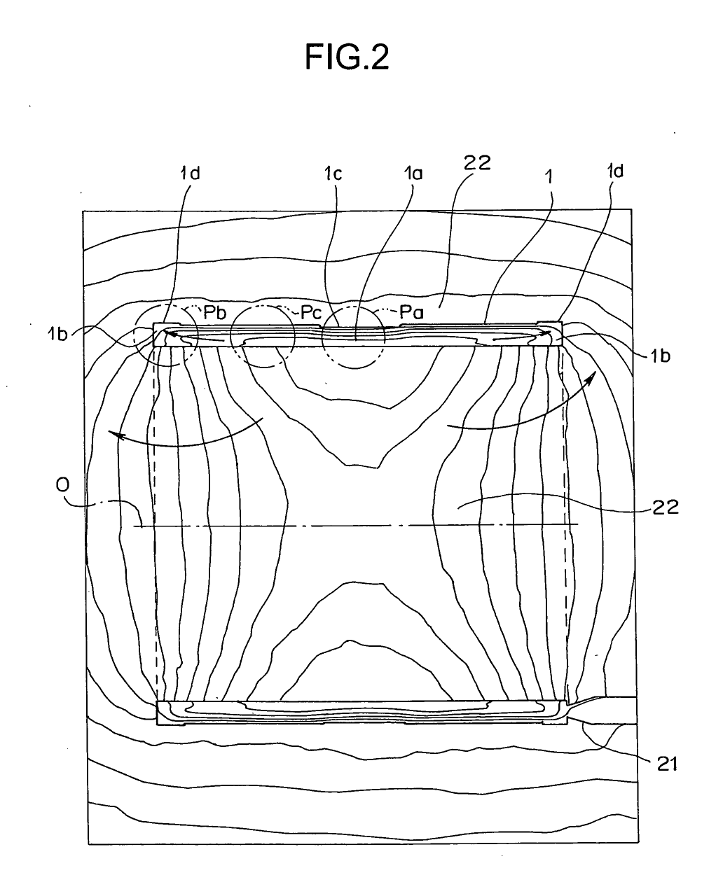

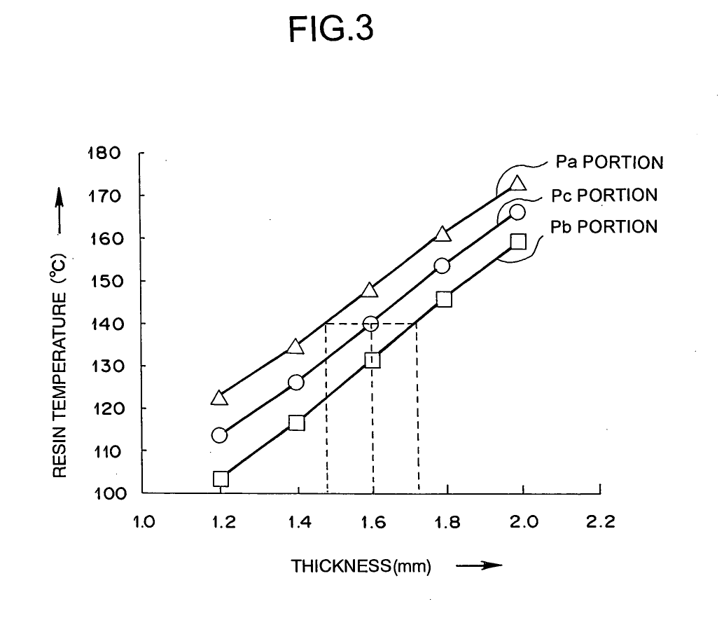

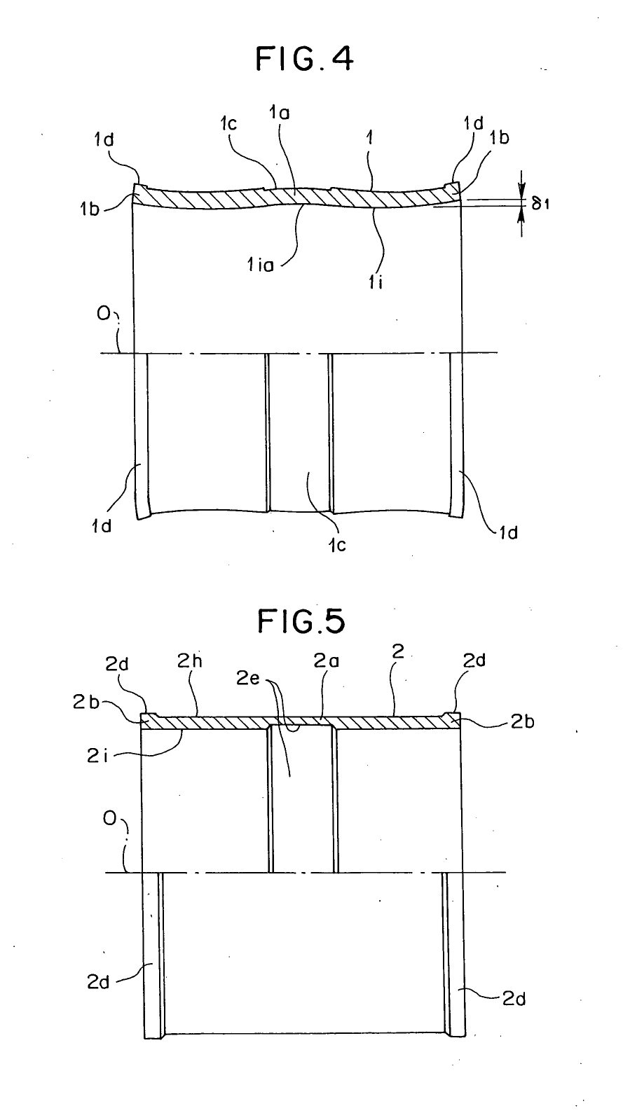

FIG. 1 is a side view showing a section of an upper half of a cylindrical member, which is a cylindrical part of a first preferred embodiment of the present invention. FIG. 2 is a diagram of temperature distributions of a die when filling of a resin is finished and the cylindrical member in isotherm display at molding of the cylindrical member (an arrow direction is this figure shows a direction in which a temperature on isotherm is lowered). FIG. 3 is a diagram showing relations between thickness (lateral axis) of an essential part of the cylindrical member in FIG. 2 and a resin temperature (temperatures of the respective essential parts when filling is finished, vertical axis). FIG. 4 is an enlarged side view of a deformed state of the cylindrical member caused by molding showing an upper half section.

A cylindrical member 1 of this preferred embodiment is produced by injection molding and is a resin cylindrical part whose end faces are open. This is a cylindrical member having an axis center O as shown in FIG. 1, such as what can be used as a lens barrel member for a camera, which is a precision device.

The cylindrical member 1 has a cylindrical shape having a substantially uniform thickness in the circumferential direction and both end-face edge portions 1b opened with a length L, an outer diameter D (including a thick edge portion) and a substantially uniform thickness t0. And a band-state groove portion 1c is provided for forming a thin portion along an outer circumference 1h of a cylindrical center portion 1a forming a cylindrical portion. A thick edge portion 1d is provided along the outer circumference 1h of the both end-face edge portions 1b forming the cylindrical portion.

Suppose that a groove width of the band-state groove portion 1c is AL and a depth to give the thickness decrement as At. Also, suppose that the width of the thick edge portion 1d is BL and the thickness increment (step) of the thick edge portion 1d as Bt.

For the cylindrical member 1, a heated/molten resin is injected/poured into a die 22 with a temperature lower than that of the molten resin and as soon as the fluid state is finished (filling finished), it is cooled/solidified. In the case of polycarbonate resin, for example, its melting temperature is approximately 300° C., while the die temperature is approximately 100° C.

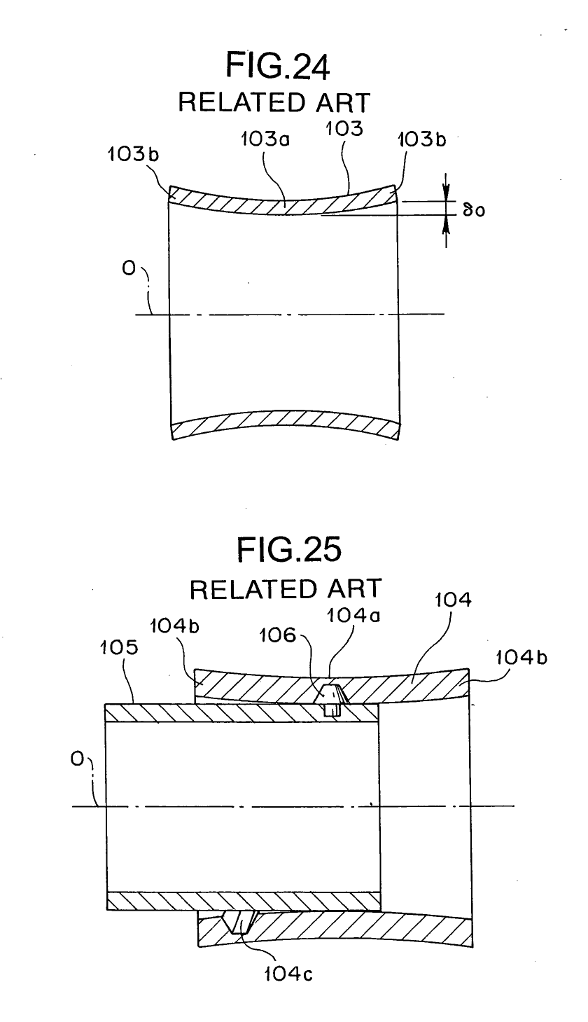

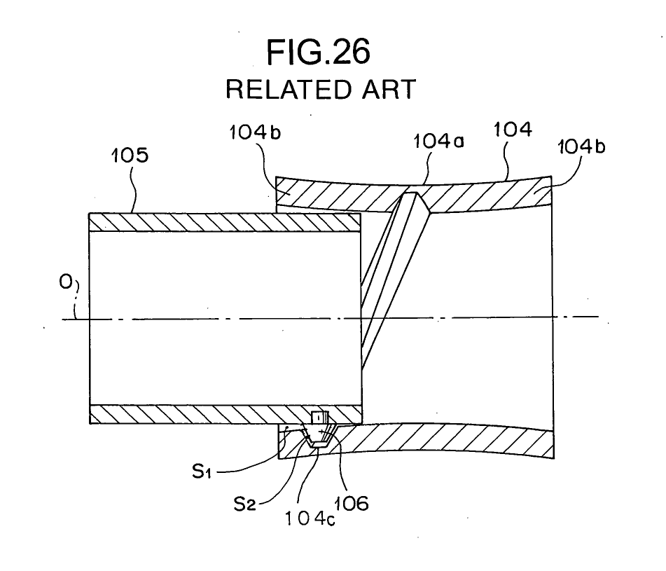

FIG. 2 shows temperature distributions when the molten resin is poured into the die 22 and fluidity is finished (filling completed), and heat of the resin is transmitted from the inner circumference of the cylindrical center portion 1a having the highest temperature to inside the die 22. The heat is also transmitted from the outer circumference of the cylindrical center portion 1a to the outside of the die 22. However, since the band-state groove portion 1c along the outer circumference 1h is provided in the cylindrical center portion 1a in the cylindrical member 1 and this portion is thin, a held heat amount is small by that amount and the member is easily cooled as compared with the conventional cylindrical member 103 shown in FIG. 24. And the temperature does not get high when filling is finished.

On the other hand, the heat is transmitted from the both end-face edge portions 1b to the die 22 in three directions, and the temperature of the both end-face edge portions 1b tends to be lower than that of the other portions. However, in the cylindrical member 1, since the thick edge portion 1d is provided at the both end-face edge portions 1b, the heat amount held by that portion is large. Therefore, the temperature distribution of the entire cylindrical part is made uniform as compared with the conventional example (the state is shown by isotherms of the both end-face edge portions 1b in FIG. 2).

With regard to the shape of the cylindrical member 1 cooled to a room temperature after solidification, since a high temperature is not reached at completion of filling due to provision of the band-state groove portion 1c at the cylindrical center portion 1a as shown in FIG. 4, a contraction amount is suppressed, and a center portion 11a of an inner circumference 1i is not contracted inward or rather it is recessed slightly relatively outward.

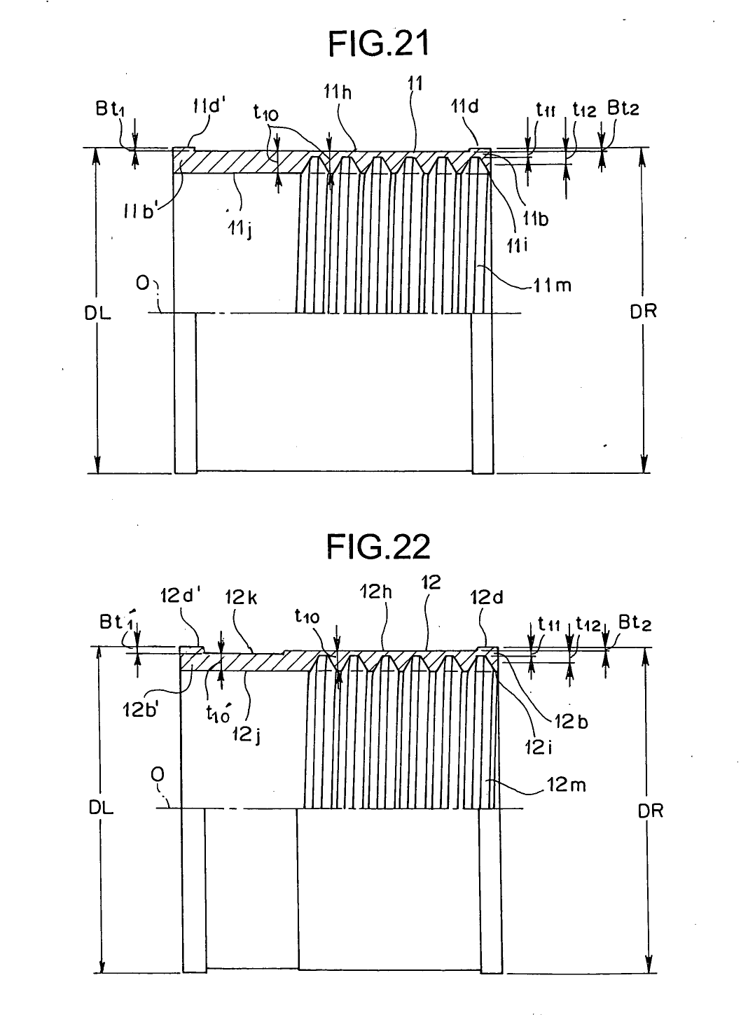

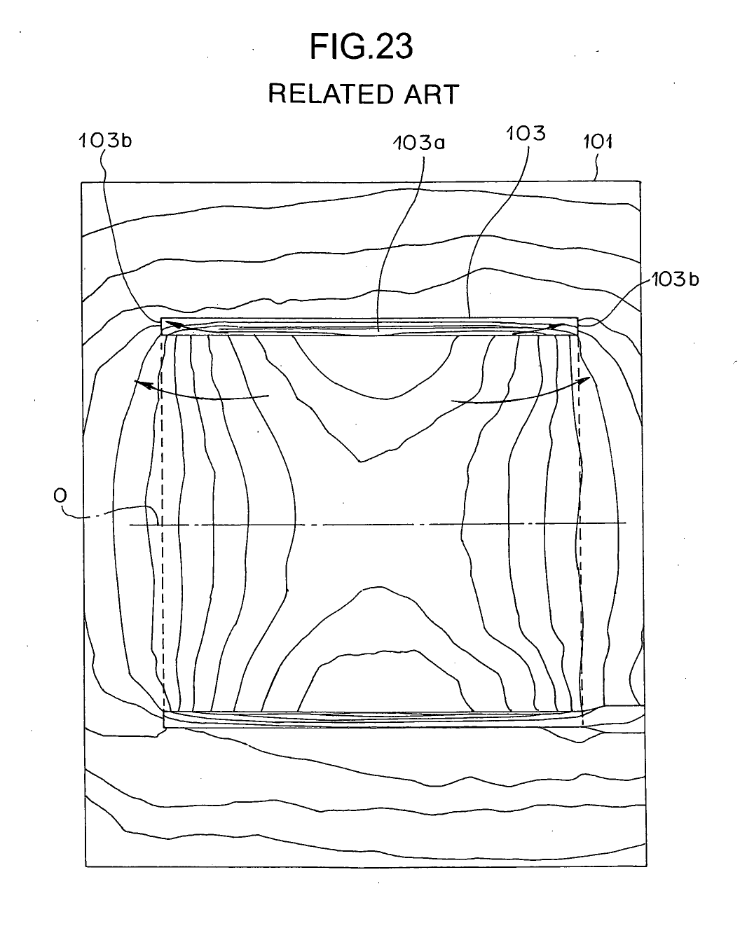

Moreover, since the thick edge portion 1d is provided at the both end-face edge portions 1b, drop of temperature is suppressed as compared with the conventional example, which reduces a difference in the contraction amounts (in comparison with the conventional cylindrical member in FIG. 21), and as a result, a dimensional difference (deformation amount) δ1 on the radius caused by spread of the ends can be kept small.

Relations between the thickness of each essential part of the cylindrical member 1 and the resin temperature (when filling is completed) will be described. In a Pa portion around the band-state groove portion 1c of the cylindrical member 1, a Pb portion around the thick edge portion 1d and a Pc portion, which is an average thickness portion, with respective thickness at respective positions in the axial direction, the resin temperature is changed according to the thickness as shown in FIG. 3 due to the specific shape of the cylindrical member 1 where each of them is located.

In order that a difference in molding contraction amounts in them is to be eliminated, it is necessary to keep the resin temperatures at the Pa portion, Pb portion and Pc portion as uniform as possible as mentioned above. For example, when an average thickness t0 of the Pc portion is set to 1.6 mm, as will be described later, the following state will be obtained. That is, if the thickness of the Pa portion is 1.6 mm−groove depth At, or when a specific dimension as will be described later is applied, it is 1.6 mm−0.12 mm=1.48 mm and moreover, if the thickness of the Pb portion is 1.6 mm+padding amount Bt, when a dimension as will be also described later is applied, it is 1.6 mm+0.12 mm=1.72 mm, the resin temperatures becomes the same as shown in FIG. 3, and there is little difference between the contraction amounts.

As mentioned above, in the vicinity of the center of the cylindrical member 1, the resin is easily cooled since the thickness is made smaller by the band-state groove portion 1c, and the temperature of the die 22 on the inner both faces in this area is high, but the resin temperature in this area is not much different from the other portions. Moreover, since the thickness is large on the both ends of the cylindrical member 1, the resin is hardly cooled, and even if it is in contact with the die 22 on three faces and the heat of the resin moves easily to the die, the provision of the thick edge portion 1d makes the resin temperature at both ends not much different from the other portions. That is, the resin temperature in the cylindrical member 1 tends to be more uniform in the entirety. Therefore, the contraction rate in molding is equalized, and deformation of the cylindrical member 1 due to molding can be suppressed.

It was found out that the desirable shapes of the band-state groove portion 1c and the thick edge portion 1d with respect to the cylindrical member 1 having the length L, outer diameter D and average thickens t0 preferably have dimensions satisfying that:

the groove width AL of the band-state groove portion 1c is:
0.15×L≦AL≦0.4×L (1)

the depth At of the band-state groove portion 1c is:
0.05×t0≦At≦0.1×t0 (2)

the width BL of the thick edge portion 1d is:
t0≦BL≦2×t0 (3)

the padding amount Bt of the thick edge portion 1d is:
0.05×t0≦Bt≦0.1×t0 (4)

For the cylindrical member 1 of the shape with the length L=30 mm, outer diameter D=30 mm, thickness t0=1.6 mm as an experiment, suppose that the shape with the groove width AL=0.2×L=6 mm of the band-state groove portion 1c, the depth At =0.075×t0=0.12 mm of the band-state groove portion 1c, the width BL=1.25×t0=0.12 mm of the thick edge portion 1d and the padding amount Bt=0.075×t0=0.12 mm of the thick edge portion 1d is employed, a preferable result of a difference in radial dimension (deformation amount) δ1=0.01 mm was obtained due to spread of the ends as shown in FIG. 4.

As mentioned above, by employing the shape of the cylindrical member 1 of this preferred embodiment, a cylindrical part with little molding deformation can be obtained without using a complicated molding device or complicated die modification.

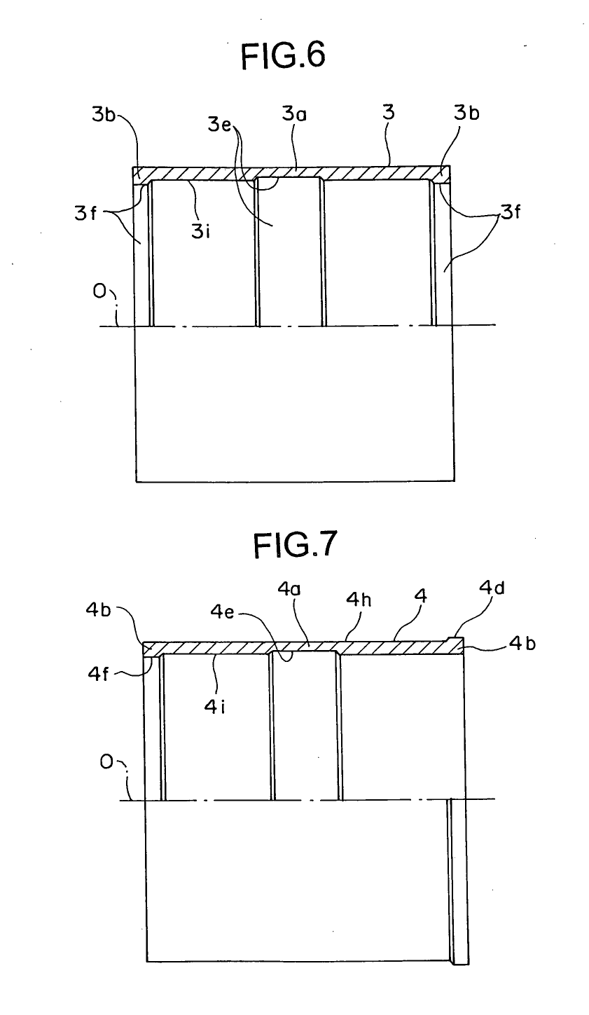

Next, 6 variations of the cylindrical member 1 of the above-mentioned first preferred embodiment will be described using FIGS. 5 to 12. FIGS. 5, 6 are side views showing a section of an upper half of the cylindrical member, which is a cylindrical part of a first variation and a second variation.

In a cylindrical member 2 of the first variation, a band-state groove portion 2e is provided at an inner circumference 2i of a cylindrical center portion 2a as shown in FIG. 5, and a thick edge portion 2d along an outer circumference 2h is provided at the both end-face edge portions 2b.

In a cylindrical member 3 of the second variation, a band-state groove portion 3e is provided at an inner circumference 3i of a cylindrical center portion 3a as shown in FIG. 6, and a thick edge portion 3f along an inner circumference 3i is provided at the both end-face edge portions 3b. Note that the other shape of both the first and second variations is the same as that of the first preferred embodiment.

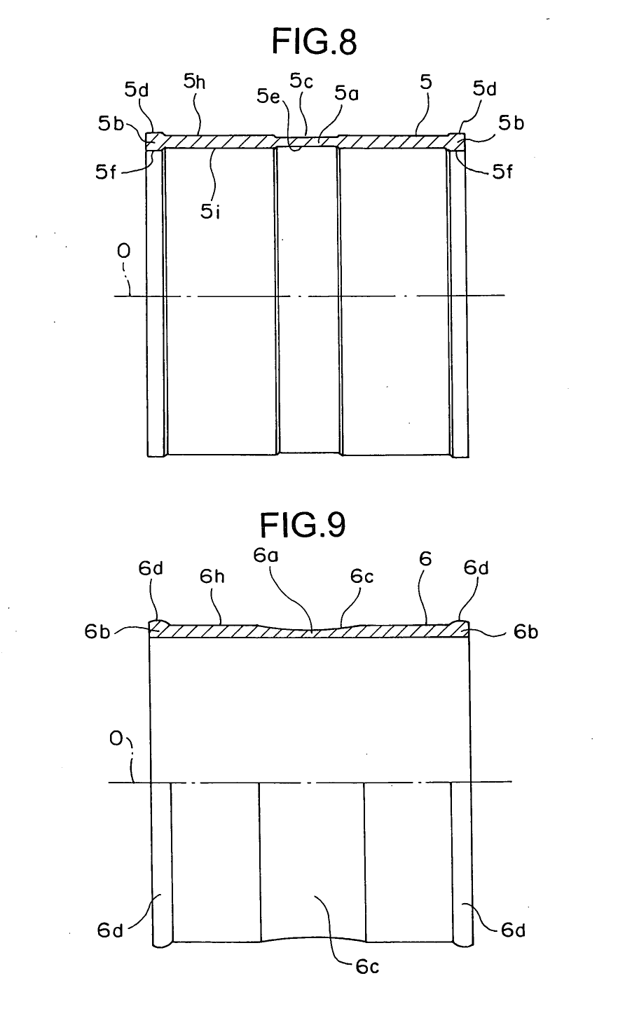

FIGS. 7, 8 are side views showing a section of an upper half of the cylindrical member, respectively, which is a cylindrical part of a third variation and a fourth variation.

In a cylindrical member 4 of the third variation, a band-state groove portion 4e is provided at an inner circumference 4i of a cylindrical center portion 4a as shown in FIG. 7, and a thick edge portion 4d along an outer circumference 4h is provided at one end-face edge portion 4b and a thick edge portion 4f along the inner circumference 4i at the other end-face edge portion 4b.

In a cylindrical member 5 of the fourth variation, band-state groove portions 5c and 5e are provided at an outer circumference 5h and an inner circumference 5i of a cylindrical center portion 5a as shown in FIG. 8, and thick edge portions 5d, 5f along an outer circumference 5h and the inner circumference 5i are provided at the both end-face edge portions 5b. Note that the other shape of both the third and fourth variations is the same as that of the first preferred embodiment.

The thick edge portion is preferably provided at both ends, but that may be provided only at one end so that deformation at least on the side where the thick edge portion is provided can be suppressed.

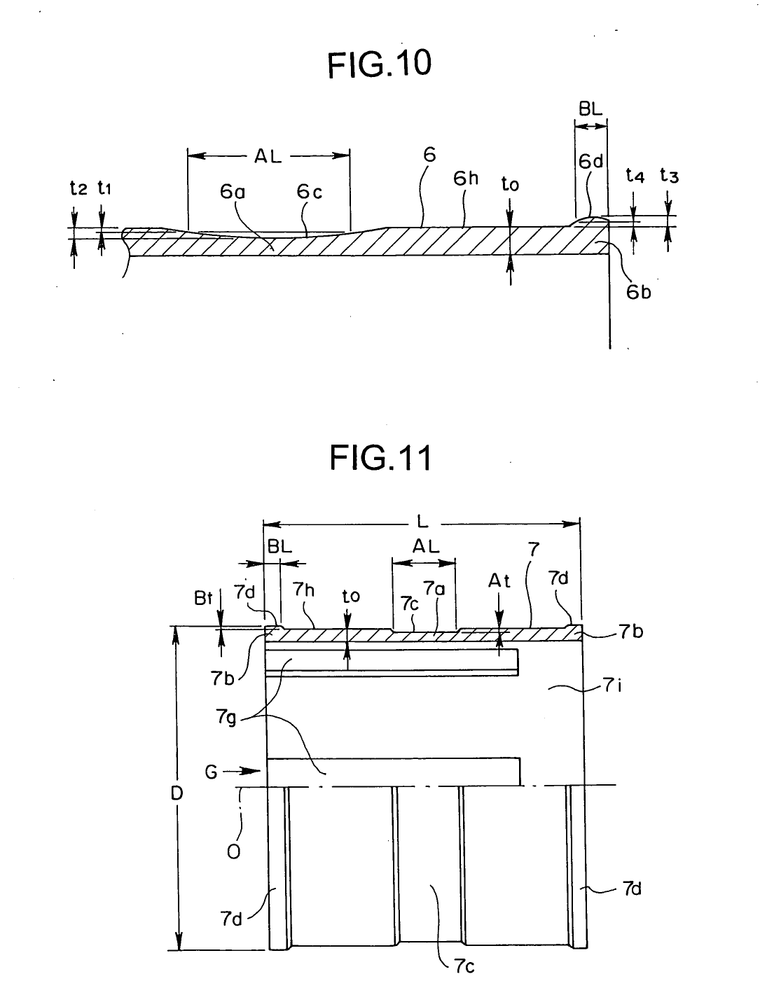

FIG. 9 is a side view showing a section of an upper half of the cylindrical member, which is a cylindrical part of a fifth variation. FIG. 10 is an enlarged sectional view of an essential part of the cylindrical member.

A cylindrical member 6 of this variation is different in a point that a band-state groove portion 6c and a thick edge portion 6d formed at a center portion 6a and both end edge portions 6b of an outer circumference 6h are not formed in steps as in the first preferred embodiment but formed in an inclined surface whose thickness is gradually changed or in a curved surface.

In this case, the groove width AL (groove width of a portion with an effective groove depth of t1 or more in the entire groove depth t2) of the band-state groove portion 6c refers to the width that the groove depth At is:
0.05×t0≦At≦0.1×t0 (5)

and the width BL (width giving an effective padding amount t4 or more in the entire padding amount t3) of the thick edge portion 6d refers to the width that the padding amount Bt from the surface of the outer circumference is:
0.05×t0≦Bt≦0.1×t0 (6)

and the values of the groove width AL, the width BL in the above-mentioned first preferred embodiment can be applied.

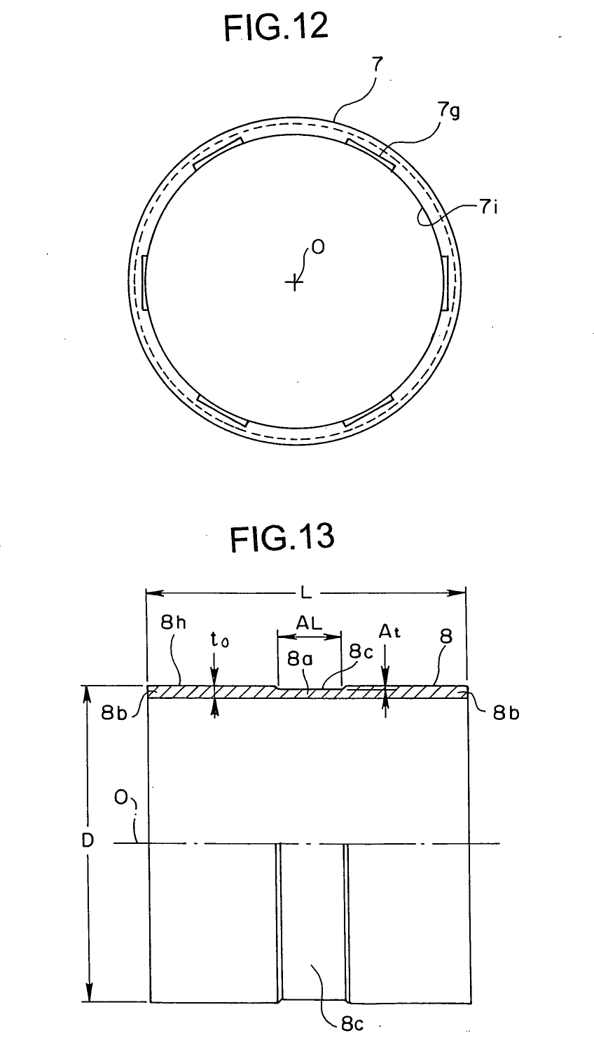

FIG. 11 is a side view showing a section of an upper half of a cylindrical member, which is a cylindrical part of a sixth preferred embodiment. FIG. 12 is a view on arrow G in FIG. 11.

A cylindrical member 7 in this variation can be applied to a member having a groove 7g along an axis center O at an inner circumference 7i, but in this case, a band-state groove portion 7c is also provided along the circumferential direction of an outer circumference 7h of a center portion 7a and a thick edge portion 7d is provided along the circumferential direction of the outer circumference 7h of both end-face edge portions 7b as with the first preferred embodiment.

The shapes of the band-state groove portion and the thick edge portion applied in the first preferred embodiment can be employed as they are for this variation. However, the thickness of a portion other than the groove 7g portion is applied to the average thickness t0 of the cylindrical member 7.

With the cylindrical members 2, 3, 4, 5, 6, 7 of each of the above-mentioned variations, uneven contraction amounts at molding can be suppressed respectively by the same action as that of the cylindrical member 1 in the first preferred embodiment, and a cylindrical part in the shape with high accuracy with less deformation caused by molding can be obtained.

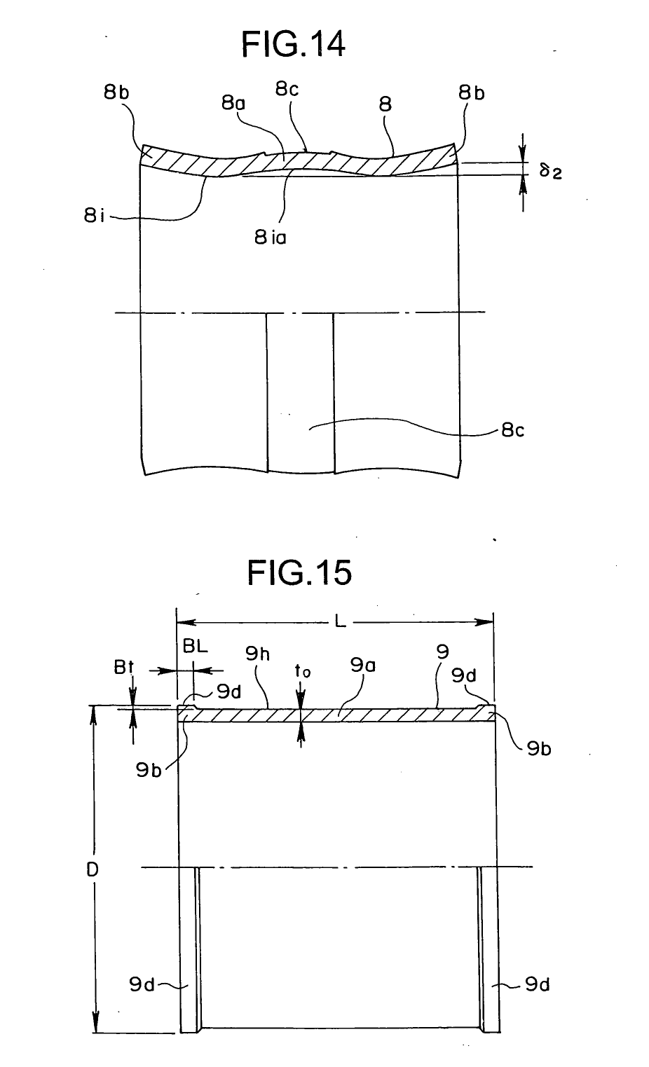

Next, a cylindrical member of a second preferred embodiment of the present invention will be described using FIGS. 13 and 14.

FIG. 13 is a side view showing a section of an upper half of a cylindrical member, which is a cylindrical part of the second preferred embodiment of the present invention.

FIG. 14 is an enlarged side view of a deformed state caused by molding of the above cylindrical member shown in a section of an upper half.

A cylindrical member 8 of this preferred embodiment is produced by injection molding and is a resin cylindrical part whose end faces are open. It has, as shown in FIG. 13, an axis center O, a constant outer circumferential surface of an outer diameter D and a substantially uniform thickness t0. And the thick edge portion provided at the both end-face edge portions 8b with respect to the cylindrical member 1 of the above first preferred embodiment is not provided, but only a band-state groove portion 8c forming a thin portion along an outer circumference 8h of a center portion 8a is provided. When only the band-state groove portion 8c is provided at the center portion 8a in this way, the center portion 8a is brought into a thin state, and resin temperature is suppressed. Therefore, as shown in FIG. 14, a center portion 81a of an inner circumference 8i is not largely contracted inward but tends to be slightly recessed relatively outward to the contrary, by which a dimensional difference (deformation amount) in the radial direction between the inner circumference and the end-face edge portion is reduced.

As a preferable shape of the band-state groove portion 8c, when the entire length of cylindrical member 8 is L and the thickness of the cylindrical portion is t0, the groove width AL is:
0.15×L≦AL≦0.4×L (7)

and the groove depth At is:
0.075×t0≦At≦0.2×t0 (8)

Suppose that the groove width AL=0.2×L=6 mm of the band-state groove portion 8c for the cylindrical member 8 with the outer diameter of 30 mm, length of 30 mm and thickness of 1.6 mm, and the groove depth At=0.1 t=0.16 mm is applied experimentally, a dimensional difference (deformation amount) δ2 on a radius between the inner circumference 8i and the end-face edge portion 8b is 0.02 mm, which is smaller than the deformation amount of the conventional cylindrical member 103 shown in FIG. 22.

In the cylindrical member 8 in this preferred embodiment, the temperature of the die in the vicinity of the center portion 8a of the inner circumference 8i gets higher at molding. However, since the vicinity of the center portion of the cylindrical member 8 is thin, the resin is easily cooled. Therefore, molding contraction in the vicinity of the center portion of the cylindrical member 8 is not particularly increased and molding deformation amount can be suppressed. According to this preferred embodiment in this way, in addition to the effect close to that of the first preferred embodiment, since it is only necessary to change the thickness of only at the center portion 8a, there is little restriction on the shape of a molding and degree of freedom is high.

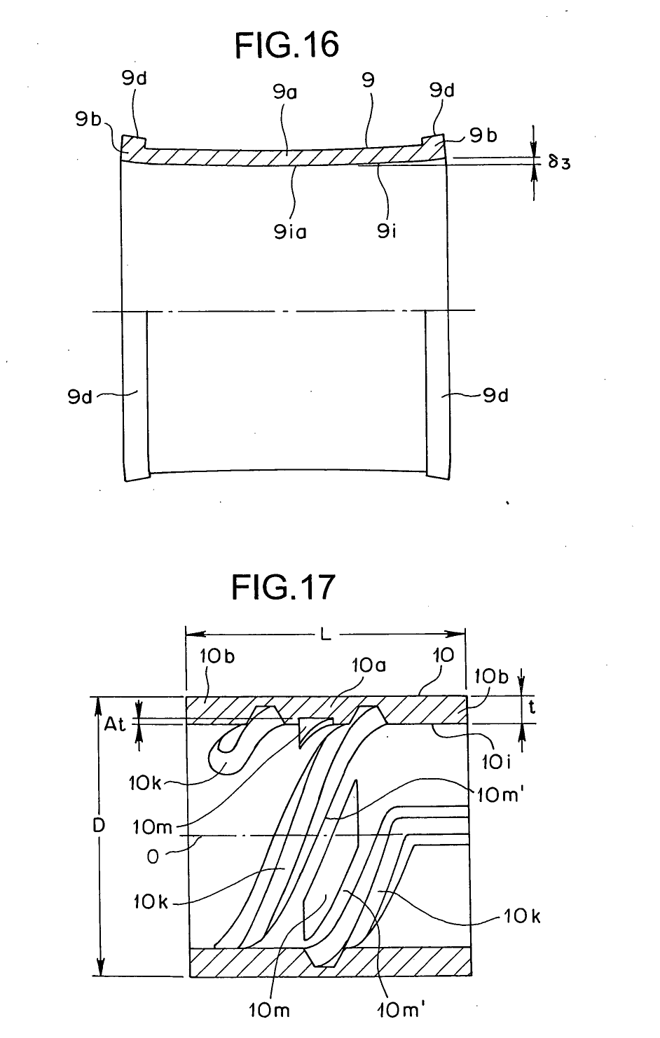

Next, a cylindrical member of a third preferred embodiment of the present invention will be described using FIGS. 15 and 16.

FIG. 15 is a side view showing a section of an upper half of a cylindrical member, which is a cylindrical part of the third preferred embodiment of the present invention. FIG. 16 is an enlarged side view of a deformed state of the above cylindrical member caused by molding showing an upper half section.

A cylindrical member 9 of this preferred embodiment is produced by injection molding and is a resin cylindrical part whose end faces are open. It has, as shown in FIG. 15, an axis center O and an outer circumferential surface with a constant outer diameter (D−2×Bt). And the band-state groove portion of the center portion 9a is not provided with respect to the cylindrical member 1 in the above first preferred embodiment, but only a thick edge portion 9d along an outer circumference 9h of a both end-face edge portion 9b is provided. When only the thick edge portion 9d is provided in this way, even if there is expansion inward of the center portion 9ia of an inner circumference 9i as shown in FIG. 16, deformation in the radial direction of the both end-face edge portions 9b is small with respect to the inner circumference 9i, by which a difference in the radial direction between the inner circumference 9i and the end-face edge portion 9b is reduced.

As a preferable shape of the thick edge portion 9d, when the uniform cylindrical portion thickness of the cylindrical member 8 is t0, the width BL of the thick edge portion 9d is:
t0≦BL≦2×t0 (9)

and the padding amount Bt is:
0.1× t0≦Bt≦0.3×t0 (10)

Suppose that the width BL=1.25× t0=2 mm of the thick edge portion 9d for the cylindrical member 9 with the outer diameter of 30 mm, length of 30 mm and thickness of 1.6 mm, and the padding amount Bt=0.2×t0=0.32 mm is applied experimentally, a dimensional difference (deformation amount) δ3 on a radius between the inner circumference 9i and the end-face edge portion 9b is 0.01 mm, which is smaller than the dimensional difference of the conventional cylindrical member 103 shown in FIG. 22.

In the cylindrical member 9 of this preferred embodiment, since the both-end edge portions 9b are in contact with the die on three faces at molding, the heat of the resin is easily moved to the die. However, since the thick edge portion 9d is provided at both end-face edge portions of the cylindrical member 9, the resin is hardly cooled, and even when it is in contact with the die on three faces and the heat of the resin is easily moved to the die, the resin temperature in the vicinity of the thickness center of the both end-face edge portions is not particularly lowered. Therefore, a difference in contraction amounts at the both end-face edge portions 9b can be suppressed as compared with the center portion, by which deformation by molding is reduced.

According to this preferred embodiment in this way, it is only necessary to change the thickness only of both ends as compared with the first preferred embodiment, and freedom of shape of the molding is high. The thick edge portion is preferably provided at both ends but it may be provided only at one end, in which case a deformation amount is reduced at least on the side where the thick edge portion is provided.

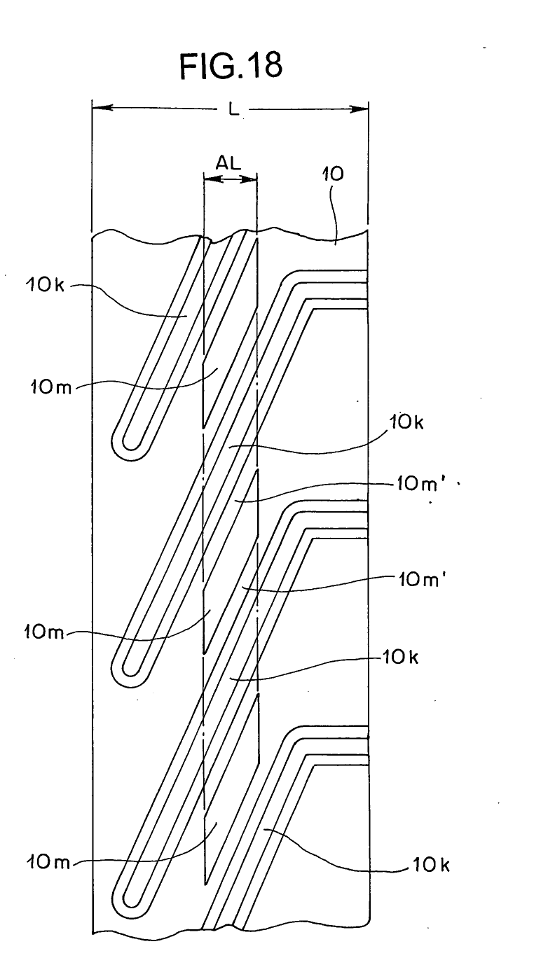

Next, a cylindrical member of a fourth preferred embodiment of the present invention will be described using FIGS. 17 and 18.

FIG. 17 is a sectional view along an axis center of a cylindrical member, which is a cylindrical part of the fourth preferred embodiment of the present invention. FIG. 18 is an extended view of the above cylindrical member seen from the inner circumference side.

A cylindrical member 10 of this preferred embodiment is a resin cylindrical part produced by injection molding with open end faces and has an axis center O as shown in FIG. 17, a constant outer diameter D and a length L. A plurality of cam grooves 10k, which are spiral grooves with bottoms passing obliquely with respect to the axis center O, are provided in an inner circumference 10i.

There is also a possibility in the cylindrical member 10 that a center portion 10a is deformed as expanding toward the inner circumference side as with the first preferred embodiment, since the temperature of the filled resin gets particularly high around the center portion 10a. Particularly in this preferred embodiment, since the cam grooves are arranged in the inner circumference, there is a possibility that trouble might occur in the fitting state between the cam follower and the cam groove in case of the above deformation.

Then, in the cylindrical member 10 of this preferred embodiment, in the vicinity of the center portion 10a of the cylindrical member 10, a plurality of recess portions 10m are provided as shown in FIG. 18 so that they are disposed in the circumferential direction in a space on the inner circumference 10i in the state held between the cam grooves so as to form a thin portion between the adjacent cam grooves 10k.

The recess portion 10m has a depth At and an axial groove width AL, and by providing this recess portion 10m, the thickness of the vicinity of the center portion 10a of the cylindrical member 10 is thinned, and the resin temperature is suppressed. Therefore, the center portion 10a of the inner circumference 10i is not expanded inward but tends to be slightly recessed relatively outward, by which a dimensional difference in the radial direction between the inner circumference and the end-face edge portion is reduced.

As a preferable shape of the recess portion 10m, when an area of a central inner circumference surrounded by the groove width AL of the cylindrical member 10 is S0 and a total sum of areas of the plurality of recess portions 10m is S1, the following relations shall be given:
S1≧S0/2 (11)

The larger the circumferential width of the recess portion 10m is, the better the effect is, but it is preferable to set it about ½ of the circumferential width on the space on the inner circumference 10i between the adjacent cam grooves 10k. Also, by slightly thinning area portions 10m′ on both sides of the recess portion 10m in the circumferential direction, a far better effect can be obtained.

According to the cylindrical member 10 of this preferred embodiment, deformation by molding of the cylindrical member in which cam grooves are provided on the inner circumferential surface can be suppressed. Moreover, the same shape can be also applied to a cylindrical member with a straight groove or opening hole other than the cam groove so as to obtain an equivalent effect.

It is also possible to suppress deformation by molding not by providing the thin recess portion 10m at the center portion 10a but by providing a thick portion at the end of the cylindrical member having a cam groove.

Moreover, in place of the cam groove on the inner circumference surface, the deformation by molding can be also suppressed by providing a thin portion at the center portion with respect to the cylindrical member in which a recess-state cam portion is provided on an outer circumferential face as in a first variation of this preferred embodiment, which will be described later. Furthermore, for the cylindrical member having a male thread portion with a predetermined width on an outer circumferential face on one end as in a second variation of this preferred embodiment, which will be described later, the deformation by molding can be similarly suppressed by forming a thick portion at the other end.

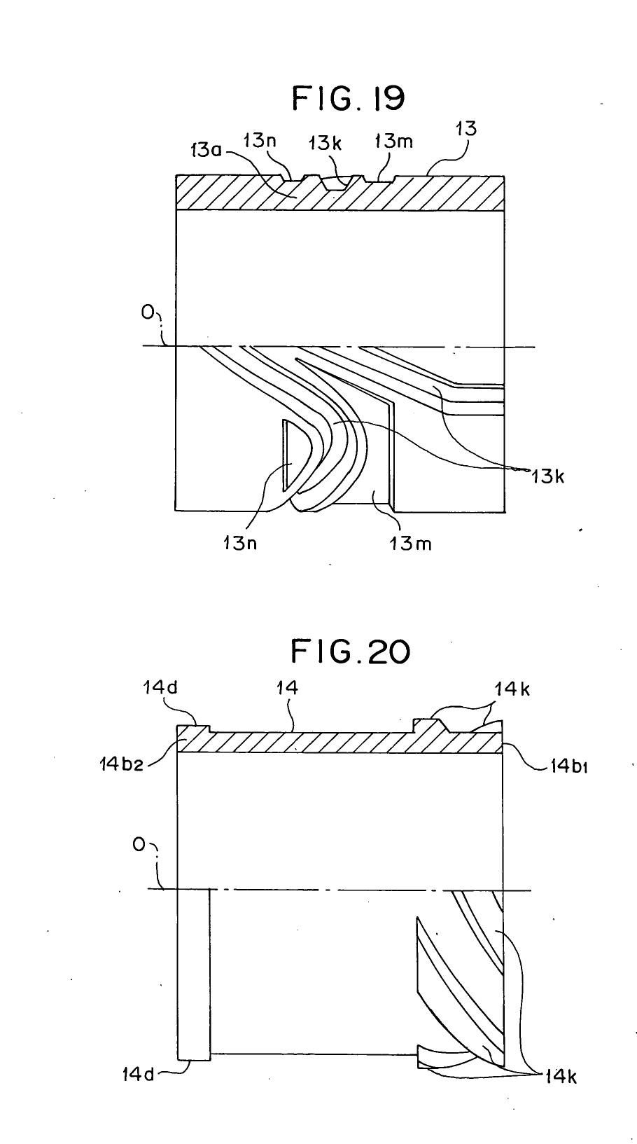

FIG. 19 is a side view showing a section of an upper half of the first variation of the cylindrical member of the fourth preferred embodiment.

A cylindrical member 13 of this variation is a resin cylindrical part produced by injection molding and whose end faces are open, and has a plurality of cam grooves 13k, which are spiral grooves with bottoms passing obliquely with respect to an axis center O over the substantially entire length of an inner circumference as shown in FIG. 19. A plurality of recess portions 13m, 13n forming thin portions are provided around the cam grooves 13k provided on an outer circumferential face of a center portion 13a of the cylindrical member 13.

By providing these recess portions 13m, 13n, the thickness in the vicinity of the center portion 13a of the cylindrical member 13 is thinned, and the resin temperature is suppressed. Therefore, the inner circumference of the center portion 10a is not contracted inward but tends to be slightly recessed relatively outward, by which a dimensional difference in the radial direction between the central inner circumference and the end-face edge portion can be reduced.

FIG. 20 is a side view showing a section of an upper half of the second variation of the cylindrical member of the fourth preferred embodiment. A cylindrical member 14 of this variation is a resin cylindrical part produced by injection molding and whose end faces are open, and has a male thread portion (male helicoid thread) 14k with a predetermined width in the direction of an optical axis O on the outer circumference on one end-face edge portion 14b1 side as shown in FIG. 20, while a thick edge portion 14d is provided on the outer circumference of the other end-face edge portion 14b2.

In this cylindrical member 14, since the male thread portion 14k on the one end-face edge portion 14b1 functions as the thick edge portion and the thick edge portion 14d is disposed on the other end-face edge portion 14b2 side, the contraction amounts of the both end-face edge portions 14b1, 14b2 with respect to the cylindrical center portion become substantially equal to that of the center portion, by which molding deformation can be kept small.

Next, a cylindrical member of a fifth preferred embodiment of the present invention will be described using FIG. 21.

FIG. 21 is a side view showing a section of an upper half of a cylindrical member, which is a cylindrical part of a fifth preferred embodiment of the present invention.

A cylindrical member 11 of this preferred embodiment is a resin cylindrical part produced by injection molding and whose end faces are open, and has an axis center O and a constant outer diameter except at ends as shown in FIG. 21. A female thread portion 11m having an inner diameter (inner circumference face portion on which the female thread is formed) 11i is provided on the right half portion of the inner circumference, and the left half portion has a smooth inner circumference face portion 11j with the same diameter continuing from the inner diameter 11i.

Since end-face edge portions 11b, 11b′ of the filled resin is also cooled by a three-faced die in this cylindrical member 11, there is a possibility that the ends are deformed outward due to a difference in contraction amounts between the end-face edge portions 11b, 11b′ with respect to the inner diameter 11i, the inner circumference 11j. Particularly in this preferred embodiment, there is a possibility that trouble might occur in the threaded state of the female thread portion.

Then, in the cylindrical member 11 in this preferred embodiment, as shown in FIG. 21, a thick edge portion 11d is provided on the outer circumference of the right end-face edge portion 11b of the cylindrical member 11 and a thick edge portion 11d′ with a different thickness is provided on the outer circumference of the left end-face edge portion 11b′. By providing these thick edge portions, the resin on the both ends are hardly cooled, and even if they are in contact with the die on three faces as mentioned above and the heat of the resin can be easily moved to the die, the resin temperature in the vicinity of the center of thickness of the both end-face edge portions does not become particularly low. Therefore, the contraction amounts of the end-face edge portions 11b, 11b′ become substantially equal to that of the center portion, by which molding deformation can be kept small.

Since the female thread portion 11m is disposed in the right half portion in the cylindrical member 11, the average thickness is different between the right half portion and the left half portion. Therefore, it is necessary that a value of a padding amount Bt2 of the right-side thick edge portion 11d should be different from that of a padding amount Bt1 of the left-side thickness edge portion 11d′.

That is, when the cylindrical portion thickness t10 of the left half portion is a thickness within a range of the inner diameter surface 11i of the female thread portion 11m in the right half portion, a thickness of the female thread portion 11m to the root is a thickness t11, and a female thread portion average thickness t12 is represented by an average of the thickness t10 and the thickness t11, the padding amount Bt2 of the thick edge portion 11d on the right end-face edge portion 11b side is preferably as follows:
0.1×t12≦Bt2≦0.3×t12 (12)

and the thickness of the right half is preferably equal to the above cylindrical portion thickness t10 and the padding amount Bt1 of the thick edge portion 11d′ on the left end-face edge portion 11b′ side is preferably as follows:
0.1×t10≦Bt1≦0.3×t10 (13)

It is preferable that a value obtained by the (3) expression applied in the first preferred embodiment is employed for the axial width of the thick edge portions 11d, 11d′. However, for the thickness t0 in the (3) expression, the above female thread portion average thickness t12 or the cylindrical portion thickness t10 is applied.

According to the cylindrical member 11 of this preferred embodiment, even if a projection and a recess portion such as a female thread portion 11m are provided on the inner circumference, the same effect as that of the cylindrical member in the third preferred embodiment can be obtained. However, the maximum outer diameters DL, DR on the left and right of the cylindrical member 11 are eventually different.

In this preferred embodiment, the female thread portion 11m is provided in the cylindrical member 11, but the same effect can be obtained by similarly providing a thick edge portion at an end-face edge portion for a cylindrical member in which a projection or a recess portion such as a male thread portion is provided on the outer circumference of the cylindrical member. However, it is necessary to change the thick edge portion on the end portion side where the male thread portion is provided such as padding disposed on the inner circumference side.

Next, a variation of the cylindrical member of the fifth preferred embodiment of the present invention will be described using FIG. 22.

FIG. 22 is a side view showing a section of an upper half of a cylindrical member, which is a cylindrical part of the above variation.

In the cylindrical member 11 of the above-mentioned fifth preferred embodiment, since the cylindrical portion thickness t10 is different from the female thread portion average thickness t12, the padding amounts Bt1 and Bt2 of the left and right thick edge portions are inevitably different. Therefore, it is unavoidable that the left and right maximum outer diameters DL, DR are different by that amount of the difference (DL>DR). A cylindrical member 12 of this variation can be applied to a case where those without a difference between right and left maximum outer diameters are required depending on equipment in which the cylindrical member is to be incorporated.

The cylindrical member 12 of this variation has substantially the same structure as that of the cylindrical member 11 of the first preferred embodiment as shown in FIG. 22, in which a female thread portion 12m having an inner diameter (inner circumference face portion where the female thread is formed) 12i is provided on a right half portion of the inner circumference and a smooth inner circumferential face portion 12j with the same diameter continuing from the inner diameter 12i is provided on a left half portion. Particularly in this variation, a recess portion 12k is provided along the circumferential direction on the left outer circumferences in a range where the female thread portion 12m is not provided.

And a right thick edge portion 12d is also provided on the outer circumference of a right end-face edge portion 12b of the cylindrical member 12, while a left thick edge portion 12d′ is also provided on the outer circumference of a left end-face edge portion 12b′. By providing these thick edge portions, the contraction amounts of the right and left end-face edge portions 12b, 12b′ are made substantially equal to that of the center portion, by which molding deformation is kept small.

In the cylindrical member 12 of this variation, by providing the recess portion 12k on the above-mentioned left outer circumference, a thickness t10′ of the left cylindrical portion is thinned, and the padding amount Bt1 required by the left thick edge portion 12d′ can be reduced, by which the left and right maximum outer diameters DL, DR can be made equal.

When a female thread portion average thickness of the thickness t11 to the root of the female thread portion 12m and the cylindrical portion thickness t10 is t12, for a value of the padding amount Bt2 of the right thick edge portion 12d on the right end-face edge portion 12b side, a value obtained by the (12) expression is employed as in the fifth preferred embodiment.

The padding amount Bt1′ of the left thick edge portion 12d′ preferably employs the following:
0.1×t10′≦Bt1′≦0.3×t10′ (14)

As mentioned above, according to the cylindrical member 12 of this variation, the same effect as that of the cylindrical member of the above fifth preferred embodiment can be obtained even if the inner circumference has a projection, recess portion such as the female thread portion 12m, and the right and left maximum outer diameters of the cylindrical member can be set equal.

For the cylindrical part of the above-mentioned respective preferred embodiments and the respective variations, a cylindrical member was applied, but not limited to that, the similar structure may be applied to a tubular member other than in the shape of a cylinder, such as a tubular member with an oval section or a tubular member with the shape close to a rectangular cylinder.

The cylindrical part according to the present invention can be utilized as a cylindrical part with good form accuracy by simple construction in a cylindrical part molded by injection molding.

The present invention is not limited to the above respective preferred embodiments but various variations can be put into practice in a range without deviating from the gist. Moreover, inventions in various stages are included in the above respective preferred embodiments and various inventions can be extracted by appropriate combination of plural disclosed structural requirements.

What is claimed is:

1. A cylindrical part molded by injection molding, including:
a cylindrical portion whose end faces are open; and
a band-state groove portion provided in a circumferential direction at the center of the cylindrical portion.

2. The cylindrical part according to claim 1, wherein the band-state groove portion is provided on an outer circumference of the cylindrical portion.

3. The cylindrical part according to claim 1, wherein the band-state groove portion is provided on an inner circumference of the cylindrical portion.

4. The cylindrical part according to claim 1, further including a thick edge portion, which is formed thickly, in a circumferential direction of both end-face edge portions of the cylindrical portion.

5. A cylindrical part molded by injection molding, including:
a cylindrical portion whose end faces are open; and
a thick edge portion, which is formed thickly, provided in a circumferential direction of both end-face edge portions of the cylindrical portion.

6. The cylindrical part according to claim 5, further including a band-state groove portion provided in a circumferential direction at the center of the cylindrical portion.

7. A cylindrical part molded by injection molding, including:
a cylindrical portion having a substantially uniform thickness and whose end faces are open; and
a thick edge portion, which is formed thickly, provided in a circumferential direction of both end-face edge portions of the cylindrical portion.

8. A cylindrical part molded by injection molding, including:
a cylindrical portion whose end faces are open having a spiral groove on an outer circumference or an inner circumferential surface; and
a plurality of recess portions aligned in a circumferential direction at the center of the cylindrical portion so that the spiral groove is provided between the recess portions.

9. A cylindrical part molded by injection molding, including:
a cylindrical portion whose end faces are open having an inner circumferential face portion on which a female thread is formed and a smooth inner circumferential face portion on which the female thread is not formed; and
a band-state groove portion provided on the outer circumference of the cylindrical portion and on the outer circumference of the smooth inner circumferential face portion.

10. A cylindrical part molded by injection molding, including:
a cylindrical portion whose end faces are open having a constant outer diameter except in the vicinity of the end faces and having an inner circumference portion on which a female thread is formed and a smooth inner circumferential face portion with a constant inner diameter on which the female thread is not formed; and
a thick edge portion, which is formed thickly, provided on the outer circumference of the cylindrical portion and in a circumferential direction of the both end-face edge portions.

11. The cylindrical part according to claim 10, wherein the thick edge portions provided on the both end-face edge portions have outer diameters different from each other.

12. A cylindrical part molded by injection molding, including:
a cylindrical portion whose end faces are open;
a male thread portion provided on the outer circumference in the vicinity of one end-face edge portion of the cylindrical portion; and
a thick edge portion, which is formed thickly, provided in a circumferential direction of the other end-face edge portion of the cylindrical portion.
